(19) United States
(12) Patent Application Publication
(10) Pub. No.: US 2014/0186480 A1
(43) Pub. Date: Jul. 3, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/952,855

(22) Filed: Jul. 29, 2013

(30) Foreign Application Priority Data
Dec. 27, 2012 (TW) 101150714

(51) Int. Cl. B29C 33/38

(52) U.S. Cl. CPC B29C 33/38
USPC 425/363; 156/446; 156/187

(57) ABSTRACT

A molding roller includes a cylindrical main body and a flexible molding film. The main body has a circumferential surface. The molding film is wound around and fixed to the circumferential surface. The molding film has a molding surface including a number of molding patterns. The molding film is made of flexible organic-inorganic composite.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metal roller. The metal roller has a circumferential surface including molding patterns to form the micro structures. The molding patterns are machined by a laser knife. However, it is difficult to machine the molding patterns on a curved surface of the metal roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 and FIG. 4 are flowcharts of a method for manufacturing a molding roller, according to a third exemplary embodiment.

### DETAILED DESCRIPTION

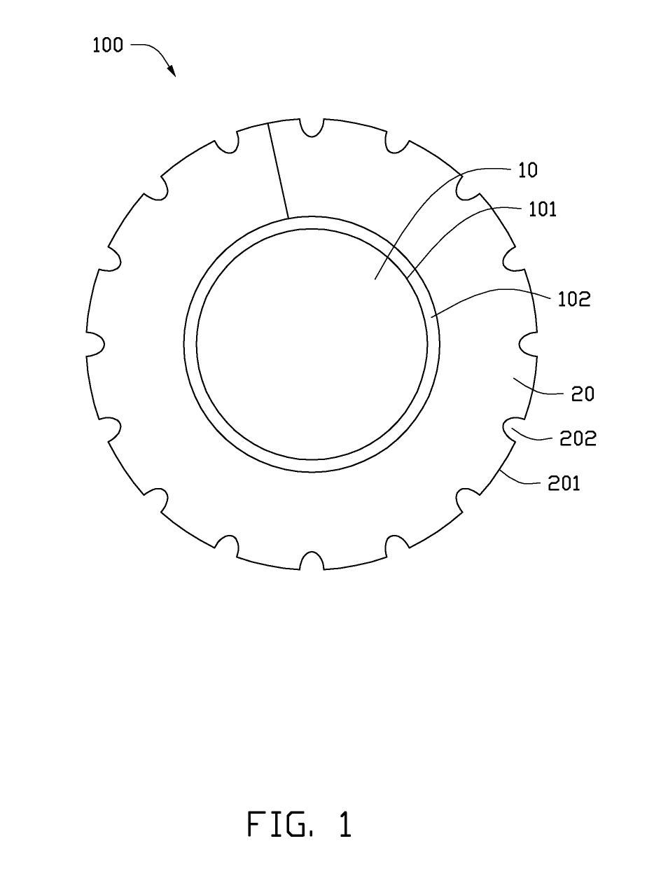

FIG. 1 illustrates a molding roller 100 in accordance with a first exemplary embodiment. The molding roller 100 includes a cylindrical main body 10 and a ring-shaped molding film 20. The molding film 20 is wound around and fixed to a smooth circumferential surface 101 of the main body 10 via adhesive glue 102. The main body 10 can be made of metal.

The molding film 20 includes a molding surface 201 opposite to the main body 10. The molding surface 201 defines a number of molding patterns 202. In this embodiment, the molding patterns 202 are micro-grooves defined in the molding surface 201. In other embodiments, the molding patterns 202 also can be micro-dots.

The molding film 20 is made of flexible organic-inorganic composite. In this embodiment, the organic-inorganic composite consists of poly-ether-ether-ketone (PEEK), graphite, and polytetrafluoroethylene (PTFE). The weight of the PEEK is about 70% of the total weight of the organic-inorganic composite. The sum of the weight of the graphite and the weight of the PTFE is about 30% of the total weight of the organic-inorganic composite. Because the organic-inorganic composite is easily separated from the optical films, therefore, the molding film is easily separated from optical films, and the quality of the optical films can be greatly improved.

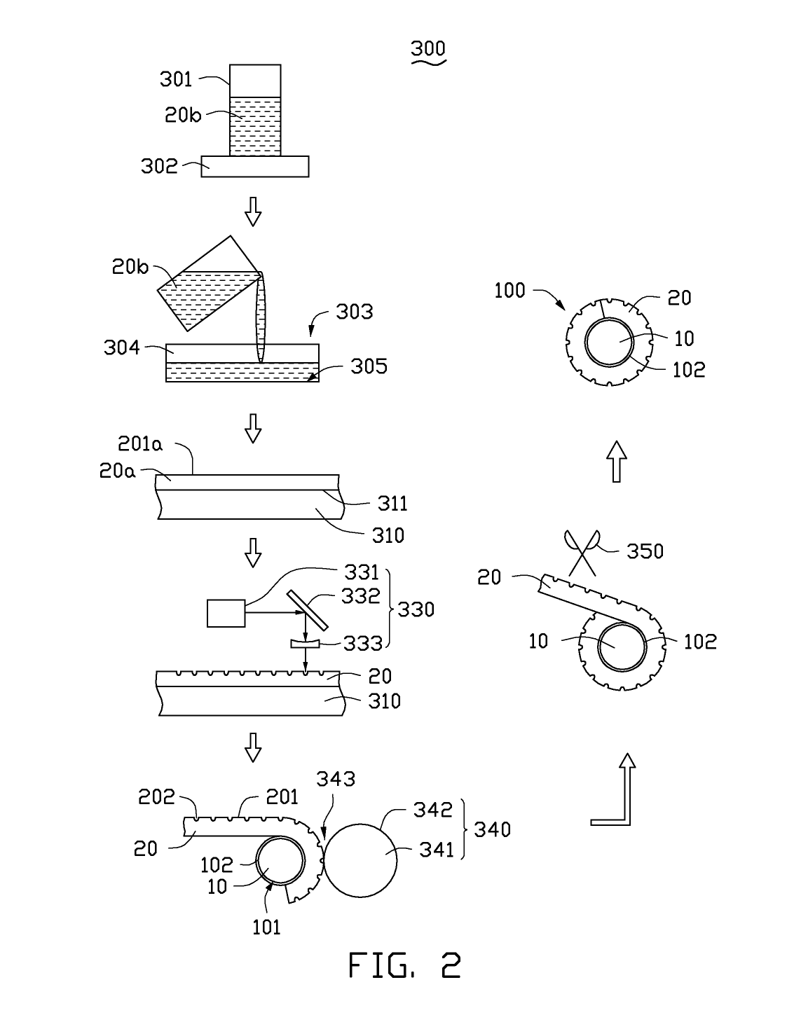

FIG. 2 shows an apparatus 300 for manufacturing the molding roller 100 according to a second exemplary embodiment. The apparatus 300 includes a container 301, a heater 302, a curing device 303, a loading plate 310, a processing device 330, a mounting device 340, and a cutting device 350.

The container 301 is used for receiving a molding-film material 20b.

The heater 302 is used for melting the molding-film material 20b at a predetermined temperature. In this embodiment, the predetermined temperature is about 390 Celsius degrees (° C.).

The curing device 303 is used for curing the melted molding film material 20b to obtain a preprocessed molding film 20a. In this embodiment, the curing device 303 includes a cubic molding chamber 304. At least one inner surface of the molding chamber 304 is a mirror surface 305 for molding a preprocessed molding surface 201a. In this embodiment, the mirror surface 305 is a bottom surface of the molding chamber 304. A temperature of the molding chamber 304 is lower than a curing temperature of a melted molding film material 20b. After the melted molding film material 20b is poured into the molding chamber 304 for a predetermined time period, the melted molding film material 20b is solidified to be a stripe-shaped preprocessed molding film 20a. The preprocessed molding film 20a has the preprocessed molding surface 201a in contact with the mirror surface 305.

The loading plate 310 is used for loading the preprocessed molding film 20a, and the preprocessed molding surface 201a is opposite to the loading plate 310. The loading plate 310 has a planar loading surface 311. Two opposite ends of the preprocessed molding film 20a are fixed to the loading surface 311 through an adhesive glue (not shown) or other fixing means.

The processing device 330 is used for forming the molding patterns 202 on the preprocessed molding surface 201a, and thus to obtain the molding film 20 and the molding surface 201. In this embodiment, the processing device 330 includes a laser knife, and includes a laser emitter 331, a reflector 332, and a converging lens 333. The laser emitter 331 is used for emitting laser rays. The transmitting direction of the laser rays is substantially parallel to the preprocessed surface 201a. The reflector 332 is used for changing the transmitting direction of the laser rays and reflecting the laser rays to the converging lens 333. The converging lens 333 converges the laser rays to the preprocessed surface 201a. In other embodiments, the reflector 332 and the converging lens 333 can be omitted, and the transmitting direction of the laser rays should be substantially perpendicular to the preprocessed surface 201a. In other embodiments, if the molding patterns 202 are V-shaped grooves, the processing device 330 may include a diamond knife having a V-shaped blade.

The mounting device 340 is used for mounting the molding film 20 on the circumferential surface 101, and includes an auxiliary roller 341 having a smooth molding surface 342. The auxiliary roller 341 is at a predetermined distance from the main body 10 to form a molding channel 343. The auxiliary roller 341 and the main body 10 are rotated in reverse directions. The circumferential surface 101 is coated with adhesive glue 102. One end of the molding film 20 is adhered on the circumferential surface 101, then the main body 10 and the auxiliary roller 341 are rotated to make the molding film 20 passing through the molding channel 343, and thus the molding film 20 is adhered to the circumferential surface 101 via the adhesive glue 102.

The cutting device 350 is used for cutting the molding film 20 to make the length of the molding film 20 substantially equal to the perimeter of the circumferential surface 101.

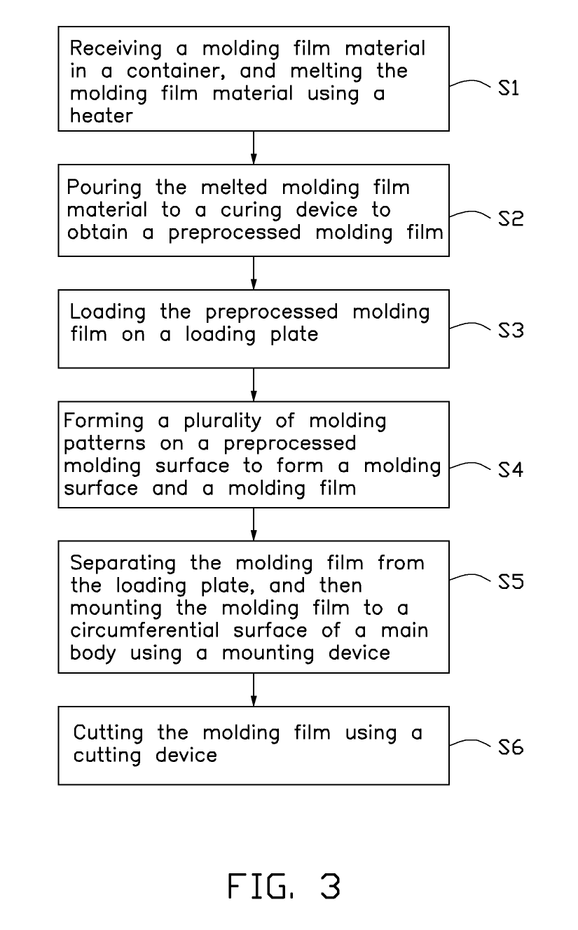

FIG. 3 shows a method for manufacturing the molding roller 100 using the apparatus 300 according to a third exemplary embodiment. The method includes the following steps.

In step S1, the molding film material 20b is received in the container 301, and the heater 302 melts the molding film material 20b at a predetermined temperature. In the third embodiment, the predetermined temperature is about 390° C.

In step S2, the melted molding film material 20b is poured into the curing device 303, and the temperature of the curing device 303 is lower than the curing temperature of the melted molding film material 20, and thus the preprocessed molding film 20a is obtained after a predetermined time period. In this embodiment, the curing device 303 includes the molding chamber 304, the bottom inner surface of the molding chamber 304 is the mirror surface 305 for molding the preprocessed molding surface 201a of the preprocessed molding film 20a.

In step S3, the preprocessed molding film 20a is positioned on the loading plate 310, and the preprocessed molding surface 201a is opposite to the loading plate 310.

In step S4, the molding patterns 202 are formed on the preprocessed molding surface 201a using the processing device 330. In the third embodiment, the processing device 330 includes a laser knife, and the laser knife emits laser rays to process the preprocessed molding surface 201a.

In step S5, the molding film 20 is separated from the loading plate 310 and is fixed on the circumferential surface 101 using the mounting device 340.

In step S6, the molding film 30 is cut to make the length of the molding film 20 substantially equal to a perimeter of the circumferential surface 101.

In other embodiments, the step S5 and the step S6 also can be interchanged.

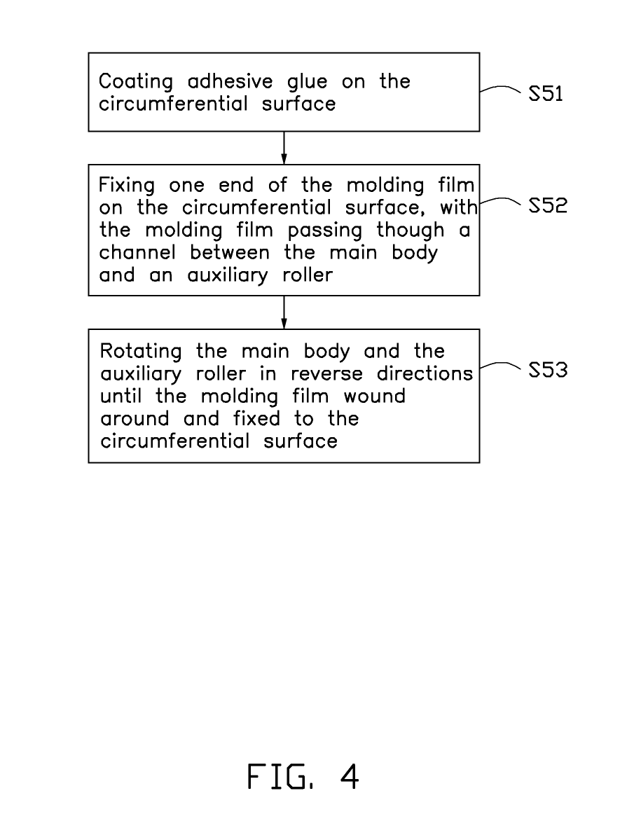

Referring also to FIG. 4, the step S5 further includes the following sub-steps.

In step S51, the circumferential surface 101 is coated with the adhesive glue 102.

In step S52, one end of the molding film 20 is adhered on the circumferential surface 101, and the molding surface 201 faces the auxiliary roller 341.

In step S53, the main body 10 and the auxiliary roller 341 are rotated to make the molding film 20 pass through the molding channel 343 until the molding film 20 is wound around and fixed to the circumferential surface 101.

By employing the apparatus 300 and the above described method, it is easier for the processing device 330 to machine the molding patterns 202 on the planar preprocessed molding surface 201a relative to on a curved surface. Therefore, the machining efficiency is improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a circumferential surface; and
a flexible molding film wound around and fixed to the circumferential surface, the molding film having a molding surface having a plurality of molding patterns;
wherein the molding film is made of flexible organic-inorganic composite.

2. The molding roller of claim 1, wherein a length of the molding film is substantially equal to a perimeter of the rolling surface.

3. The molding roller of claim 1, wherein the organic-inorganic composite consists of poly-ether-ether-ketone, carbon fibers, graphite, and polytetrafluoroethylene.

4. The molding roller of claim 3, wherein the weight of the poly-ether-ether-ketone is about 70% of the total weight of the organic-inorganic composite, the sum of the weight of the carbon fiber, the weight of the graphite, and the weight of the polytetrafluoroethylene is about 30% of the total weight of the organic-inorganic composite.

5. The molding roller of claim 1, wherein the main body is made of metal.

6. The molding roller of claim 1, wherein the circumferential surface is coated with an adhesive glue, and the molding film is fixed to the circumferential surface through the adhesive glue.

7. An apparatus for manufacturing a molding roller, comprising:
a container configured for receiving a molding film material;
a heater configured for melting the molding film material;
a curing device configured for molding a preprocessed molding film through curing the melted molding film material, the curing device comprising a molding chamber with at least one mirror surface for molding the preprocessed molding film, wherein a temperature of the molding chamber is lower than a curing temperature of the melted molding film material;
a loading plate for loading the preprocessed molding film having a preprocessed molding surface opposite to the loading plate;
a processing device configured for processing a plurality of molding patterns on the preprocessed molding surface to obtain a molding film;
a mounting device configured for mounting the loading film on a circumferential surface of a main body, wherein the molding patterns are opposite to the main body; and
a cutting device for cutting the molding film.

8. The apparatus of claim 7, wherein the loading plate has a planar loading surface, and the preprocessed molding film is fixed to the loading surface.

9. The apparatus of claim 7, wherein the processing device comprises a laser knife, and the laser knife emits laser light rays to process the preprocessed molding surface.

10. The apparatus of claim 7, wherein the processing device comprises a laser emitter, a reflector, and a converging lens, the laser emitter emits laser rays, the transmitting direction of the laser rays is substantially parallel to the preprocessed molding surface, the reflector changes the transmitting direction of the laser rays and reflects the laser rays to the converging lens, the converging lens converges the laser rays to the preprocessed molding surface.

11. The apparatus of claim 7, wherein the mounting device comprises an auxiliary roller spaced a predetermined distance from the main body to form a channel between the auxiliary roller and the main body, the main body and the auxiliary roller rotate in reverse directions, the circumferential surface is coated with an adhesive glue.

12. A method for manufacturing a molding roller, comprising:
receiving a molding film material in a container;
melting the molding film material using a heater;
pouring the melted molding film material to a curing device to obtain a preprocessed molding film, wherein the curing device further comprises a molding chamber with at least one mirror surface for molding the preprocessed molding film, a temperature of the molding chamber is lower than a curing temperature of the melted molding film material;
loading the preprocessed molding film on a loading plate;
forming a plurality of molding patterns on a preprocessed molding surface of the preprocessed molding film to form a molding film with a molding surface;
separating the molding film from the loading plate;
mounting the molding film to a circumferential surface of a main body using a mounting device; and
cutting the molding film using a cutting device.

13. The method of claim 12, wherein the step of mounting the molding film on a circumferential surface of a main body further comprises:
coating adhesive glue on the circumferential surface;
fixing one end of the molding film on the circumferential surface, with the molding film passing though a channel between the main body and an auxiliary roller, wherein the molding surface faces the auxiliary roller; and
rotating the main body and the auxiliary roller in reverse directions until the molding film is wound around and fixed to the circumferential surface.

14. The method of claim 12, wherein the length of the molding film is substantially equal to a perimeter of the circumferential surface.

15. The method of claim 12, wherein the molding film material is made of flexible organic-inorganic composite.

16. The method of claim 15, wherein the organic-inorganic composite consists of poly-ether-ether-ketone, carbon fibers, graphite, and polytetrafluoroethylene.
